(19) United States
(12) Patent Application Publication
(10) Pub. No.: US 2015/0078405 A1
(43) Pub. Date: Mar. 19, 2015

(54) MONITORING CLOCK ACCURACY IN ASYNCHRONOUS TRAFFIC ENVIRONMENTS

(71) Applicant: Alcatel Lucent Canada Inc., Ottawa (CA)

(72) Inventor: PETER ROBERTS, OTTAWA (CA)

(73) Assignee: Alcatel Lucent Canada Inc., Ottawa (CA)

(21) Appl. No.: 14/151,931

(22) Filed: Jan. 10, 2014

Related U.S. Application Data
(60) Provisional application No. 61/879,357, filed on Sep. 18, 2013.

(51) Int. Cl. H04L 7/00

(52) U.S. Cl. CPC H04L 7/0091
USPC 370/509

(57) ABSTRACT

Various exemplary embodiments relate to a method and related network system including one or more of the following: a first network device comprising a first clock; and a second network device comprising a second clock, wherein the first network device and the second network device are configured to employ a frequency distribution scheme to attempt to set the second clock to operate at the same frequency as the first clock; the first network device is configured to generate and transmit a synchronous stream of timing packets to the second network device, wherein the timing packets are periodically transmitted based on the first clock; and the second network device is configured to receive the synchronous stream of timing packets and determine, based on comparing the synchronous stream of timing packets to the second clock, whether the second clock is out of sync with the first clock.

### RELATED APPLICATIONS

This application claims the benefit of U.S. Provisional Application Ser. No. 61/879,357, filed on Sep. 18, 2013, the entire disclosure of which is hereby incorporated herein by reference.

### TECHNICAL FIELD

Various exemplary embodiments disclosed herein relate generally to communications networking.

### BACKGROUND

With the network distribution of a synchronous frequency reference for end applications, there are few methods available to monitor the accuracy of the delivered frequency. In environments where there is an underlying continuous bitstream being delivered (for example, T1 or E1 transport over SDH/SONET or Circuit Emulation Service), these transported signals can be monitored for frequency accuracy. However, continuous bitstream payloads are disappearing from networks. The remaining asynchronous payloads will not be useable for the monitoring of frequency accuracy.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

In the absence of a payload carrying a continuous bit stream, the only mechanism that exists to monitor the frequency accuracy is the use of an external frequency reference for comparison purposes. This requires the deployment of said reference at the location to be analyzed. Due to cost, this is not a viable solution for the multitude of sites using network delivered frequency.

By way of example, various embodiments will now be summarized for monitoring the clock accuracy in an environment of asynchronous network traffic. According to the example, there is a frequency source in Node A and it is delivering this frequency source across a network to Node B. The method of delivery could be Synchronous Ethernet, IEEE1588, Network Time Protocol (NTP), or any other clock synchronization method. The frequency reference at Node B is then provided into an end application utilizing an accurate frequency reference (e.g. a wireless basestation to align its carrier frequency, or smart monitoring devices belonging to a power grid). Node B reports that it is locked to the frequency being delivered from Node A, but it is not possible to verify that the frequency generated in Node B (recovered frequency) is aligned with the frequency in Node A (source frequency) without some external reference for comparison.

Further according to the example, Node A also generates a packet on a periodic basis driven by a timescale controlled by the source frequency. These packets are delivered to Node B over an intervening network. Node B receives these packets with variable delay introduced by the intervening network. Node B implements a timing comparator using the recovered frequency and the received periodic packets to evaluate the quality of the recovered frequency.

In a first exemplary technique, Node B shall count the number of these packets that it receives in a given time period using a timescale controlled by the recovered frequency. Node B expects are that the count will be the expected number of packets generated by Node B in the same time period. The information on the number of packets in a time period, and whether this number matches the expectation, shows whether the frequency in Node B is aligned with the frequency in Node A.

In a second exemplary technique, a buffering technique of circuit emulation is implemented for these timing packets. The buffer would drain at the rate controlled by the recovered frequency. Buffer overflow or underruns are then used to identify frequency error.

Various embodiments described herein relate to a system for monitoring clock accuracy comprising: a first network device comprising a first clock; and a second network device comprising a second clock, wherein the first network device and the second network device are configured to employ a frequency distribution scheme to attempt to set the second clock to operate at the same frequency as the first clock; the first network device is configured to generate and transmit a synchronous stream of timing packets to the second network device, wherein the timing packets are periodically transmitted based on the first clock; and the second network device is configured to receive the synchronous stream of timing packets and determine, based on comparing the synchronous stream of timing packets to the second clock, whether the second clock is out of sync with the first clock.

Various embodiments are described wherein the second network device comparing the synchronous stream of timing packets to the second clock by comparing the number of timing packets received within a window to an expected number of timing packets based on the second clock.

Various embodiments are described wherein the second network device comparing the synchronous stream of timing packets to the second clock by adding data into a buffer based on the synchronous stream of timing packets, removing data from the buffer at a rate based on the second clock, and determining whether the buffer experiences an overflow or underrun.

Various embodiments described herein relate to a network device for enabling downstream monitoring clock accuracy comprising: a network interface configured to communicate with a downstream device; and a processor configured to: communicate with the downstream device via the network interface according to a frequency distribution scheme to distribute a local clock frequency to the downstream device, periodically generate timing packets based on the local clock frequency, and transmit the generated timing packets to the downstream device via the network interface as a first synchronous stream.

Various embodiments described herein relate to a method performed by a network device for enabling downstream monitoring clock accuracy comprising: communicating, by the network device, with the downstream device according to a frequency distribution scheme to distribute a local clock frequency to the downstream device; periodically generating timing packets based on the local clock frequency; and transmitting the generated timing packets to the downstream device as a first synchronous stream.

Various embodiments described herein relate to a non-transitory machine-readable storage medium encoded with instructions for execution by a network device for enabling downstream monitoring clock accuracy comprising: instructions for communicating, by the network device, with the downstream device according to a frequency distribution scheme to distribute a local clock frequency to the downstream device; instructions for periodically generating timing packets based on the local clock frequency; and instructions for transmitting the generated timing packets to the downstream device as a first synchronous stream.

### Various Embodiments are Described

Various embodiments are described wherein, in periodically generating the timing packets based on the local clock frequency, the processor is configured to: count clock pulses generated according to the local clock frequency; and generate a timing packet when a number of counted clock pulses exceeds a predetermined threshold.

Various embodiments are described wherein the processor is further configured to: receive an asynchronous stream of data packets; and forward the asynchronous stream of data packets to the downstream node via the network interface.

Various embodiments are described wherein the processor is further configured to: communicate with an upstream device according to the frequency distribution scheme to establish the local clock frequency; receive timing packets as part of a second synchronous stream; verify the accuracy of the local clock frequency based on comparing the second synchronous stream to the local clock frequency.

Various embodiments are described wherein the processor is further configured to: initiate recovery for the local clock frequency when the processor determines, as a result of verifying the accuracy of the local clock frequency based on comparing the second synchronous stream to the local clock frequency, that the local clock frequency is not sufficiently accurate.

Various embodiments are described wherein, in verifying the accuracy of the local clock frequency based on comparing the second synchronous stream to the local clock frequency, the processor is configured to: count a number of timing packets received via the second synchronous stream within a window; estimate a number of timing packets expected to be received via the second synchronous stream within the window based on the local clock frequency; and compare the counted number to the estimated number.

Various embodiments are described network device of claim 4, wherein, in verifying the accuracy of the local clock frequency based on comparing the second synchronous stream to the local clock frequency, the processor is configured to: add data into a buffer based on the second synchronous stream, remove data from the buffer based on the local clock frequency, and monitor the buffer for at least one of overrun and underrun.

### BRIEF DESCRIPTION OF THE DRAWINGS

In order to better understand various exemplary embodiments, reference is made to the accompanying drawings, wherein:

FIG. 1 illustrates an exemplary network for distributing a clock frequency to an end application;

FIG. 2 illustrates an exemplary component diagram of a node for distributing or receiving a clock frequency;

FIG. 3 illustrates an exemplary hardware diagram of a node for distributing or receiving a clock frequency;

FIG. 4 illustrates an exemplary component diagram of an exemplary timing packet originator;

FIG. 5 illustrates an exemplary method for originating timing packets;

FIG. 6 illustrates an exemplary component diagram of an exemplary timing comparator according to a first embodiment;

FIG. 7 illustrates an exemplary method for analyzing timing packets according to the first embodiment;

FIG. 8 illustrates an exemplary component diagram of an exemplary timing comparator according to a second embodiment; and

FIG. 9 illustrates an exemplary method for analyzing timing packets according to the second embodiment.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Additionally, while various devices are described as “upstream” or “downstream” with respect to other device, it will be understood that such terms refer to the distribution of a clock frequency for synchronization and that underlying traffic may flow in any direction.

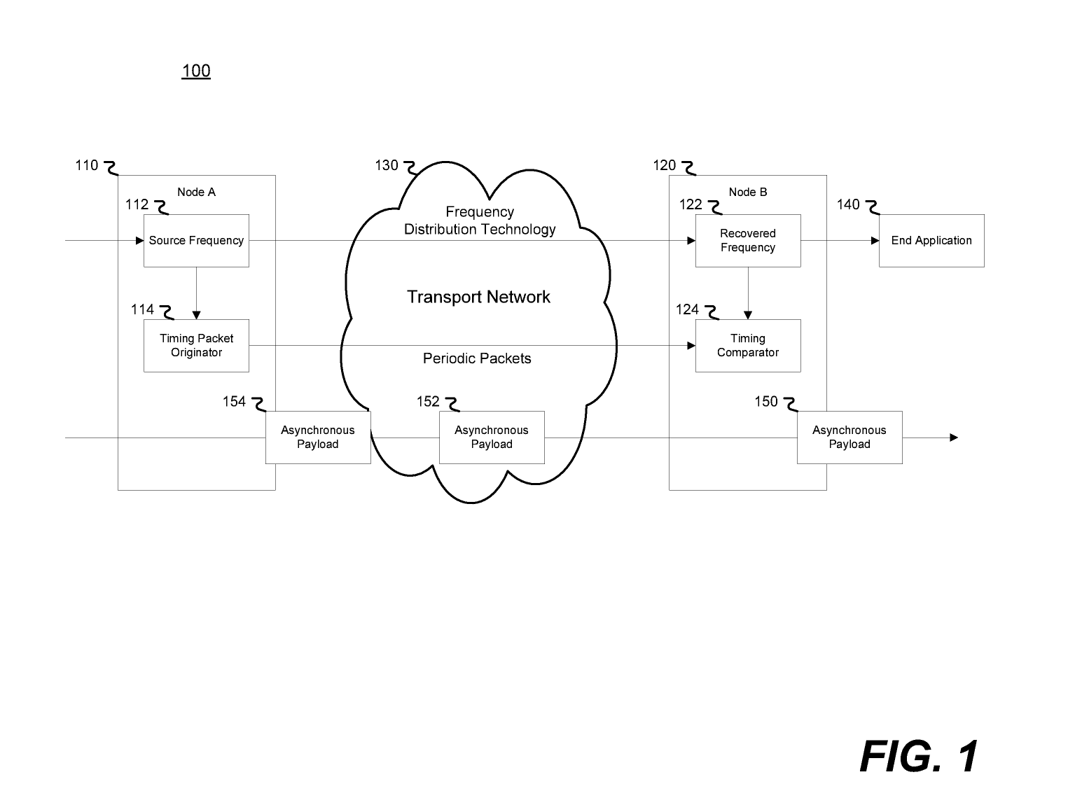

FIG. 1 illustrates an exemplary network 100 for distributing a clock frequency to an end application. As shown, the network includes two nodes, node A 110 and node B 120, in communication via a transport network 130. Additionally, node B 120 is in communication with an end application, either directly or through at least one intervening device. As will be understood, the arrangement of network 100 is only one example and various alternative arrangements may be conceived.

As shown, Node A 110 distributes a source frequency 112 to node B 120 via a frequency distribution technology. The frequency distribution technology may include any method for achieving networked clock synchronization such as, for example, Synchronous Ethernet, IEEE 1588, or Network Time Protocol (NTP). Node B 120 in turn, produces a recovered frequency 122 according to the frequency distribution technology, which may then be passed on to the end application 140, again according to some frequency distribution technology, though not necessarily the same frequency distribution technology as is implemented between the nodes 110, 120. It will be appreciated that additional devices may participate in the distribution of the frequency. For example, node A may distribute the source frequency 112 to multiple nodes (not shown) in addition to node B 120. As another example, node A 110 may recover the source frequency 112 from another upstream node (not shown) according to some frequency distribution technology. Various other alternative arrangements will be apparent.

As explained above, synchronous data streams may be utilized to ensure that the clock synchronization has been truly achieved according to the frequency distribution technology. However, in the exemplary network 100, the nodes 110, 120 only exchange asynchronous streams of packets 150, 152, 154 (even though the nodes 110, 120 may be capable of processing synchronous streams). As such, the nodes 110, 120 may not be in a position to use existing traffic to verify the validity of the recovered frequency 122.

To enable recovered frequency verification, node A 110 includes a timing packet originator 114 while node B 120 includes a complementary timing packet comparator 124. Together, the timing packet originator 114 and timing packet comparator 124 may simulate a form of synchronous connection between the nodes 110, 120, as will be explained in greater detail below. This data transfer may then be used to verify the recovered frequency 122 on node B 120.

As will be explained in greater detail below, the timing packet originator 114 periodically generates and transmits “timing packets” based on the source frequency 112. For example, the timing packet originator 114 may be configured to transmit one packet every clock cycle or one thousand packets per second as determined by the source frequency 112. The timing packets may take any form that will be recognized by the node B 120 as packets to be processed by the timing packet comparator. For example, the timing packets may be TCP/IP packets addressed to a port associated with the timing packet comparator and including zero payload or a dummy payload. Various other embodiments of a timing packet will be apparent. The timing packet comparator 124 may then treat the timing packet stream as a synchronous stream and thereby verify the recovered frequency 122. Various methods for using the timing packet stream to verify the recovered frequency will be explained in greater detail below.

It will be apparent that additional pairs of timing packet originators and timing packet comparators (not shown) may be implemented to verify the clock distribution at other legs of its path. For example, a timing packet originator and timing packet comparator (not shown) may be implemented between node B 120 and the end application 140 to verify the frequency recovered on the end application 140. As another example, in embodiments wherein node A 110 distributes the source frequency 112 to multiple nodes (not shown) other than node B 120, the timing packet originator 114 may additionally transmit timing packets to additional timing comparators (not shown) provided in those other nodes. As yet another example, in embodiments where node A 110 receives the source frequency 112 from another node (not sown) the node A 110 may include a timing packet comparator (not shown) to receive timing packets from a timing packet originator (not shown) of the other node, and thereby verify the source frequency. Various other arrangements of timing packet originator/comparator pairs within a network will be apparent.

According to various alternative embodiments, the timing packet stream utilized by the timing packet comparator 124 may not originate from node A and, instead, may originate from another node within the network such as a dedicated timing packet originator node or another node within the distribution chain or tree for the frequency. Such separate node may also be provisioned with the distributed frequency and transmit the timing packets based on the frequency. In various embodiments, the separate node may be provisioned at a different stratum than node A 110 and, for example, may be part of the source clock at stratum 0. Various other locations within the network for a separate timing packet originator will be apparent.

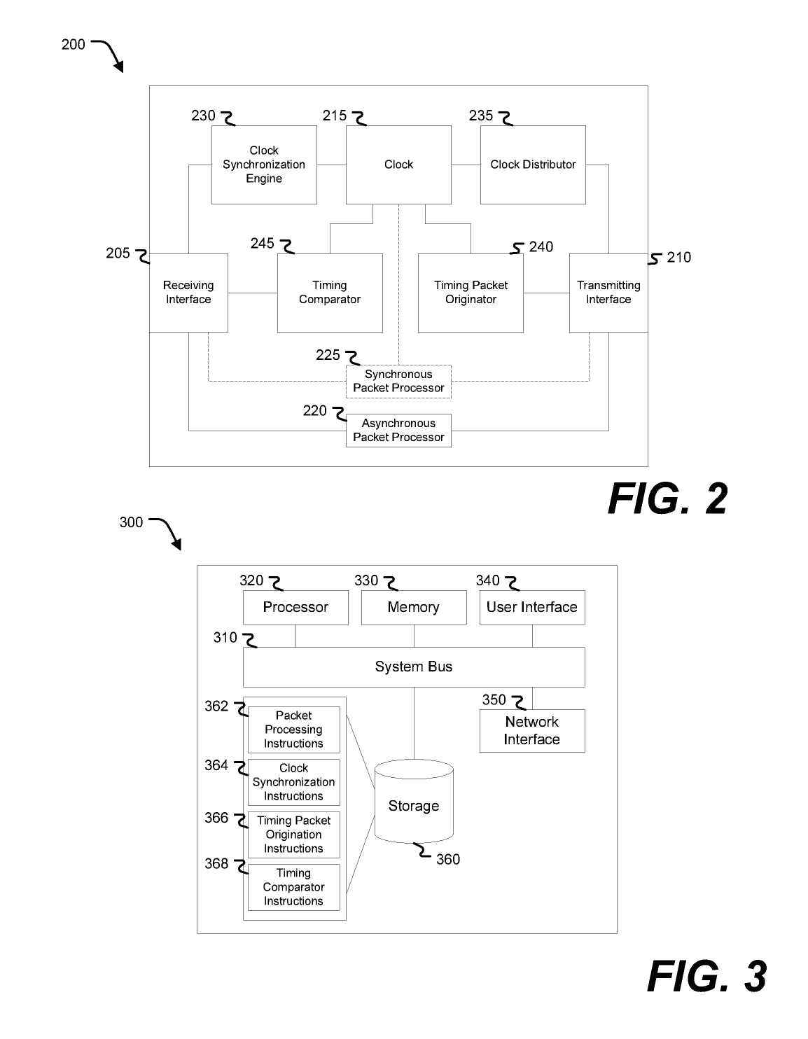

FIG. 2 illustrates an exemplary component diagram of a node 200 for distributing or receiving a clock frequency. The node 200 may correspond to node A 110 or node B 120 of the exemplary network 100. As shown, the node 200 includes a receiving interface 205 for receiving packets and a transmitting interface 210 for transmitting packets. It will be understood that the receiving interface 205 and transmitting interface 210 may be portions of the same hardware interface and may each include multiple ports for communication with other devices.

The node 200 is also shown to include an asynchronous packet processor 220 for enabling the forwarding or other processing of asynchronous packets via the node. In various embodiments, the node may also include a synchronous packet processor 225 to enable forwarding or other processing of synchronous data streams. However, even where the synchronous packet processor 225 is present, the node 200 may not actually be deployed to process synchronous data streams and, as such, may receive no such traffic.

The node 200 also includes a clock 215 that may be frequency locked with at least one other device using a frequency distribution technology as previously described. As such, the node 200 may include a clock synchronization engine 230 or a clock distributor 235. The clock synchronization engine 230 may include hardware or machine-executable instructions encoded on a machine-readable medium configured to recover a frequency from another node that is distributing its own clock frequency. After recovering the frequency, the clock synchronization engine 230 may modify the clock 215 to operate according to the recovered frequency.

The clock distributor 235 may include hardware or machine-executable instructions encoded on a machine-readable medium configured to distribute the current frequency of the clock 215 to one or more other nodes. Such distribution may enable a clock synchronization engine (not shown) at the downstream node to recover the clock signal and synchronize the downstream clock (not shown) to the local clock 215.

To enable recovered frequency verification at a downstream node, the node 200 may be provided with a timing packet originator. As will be described in greater detail below, the timing packet originator 240 may include hardware or machine-executable instructions encoded on a machine-readable medium configured to transmit a periodic stream of timing packets to one or more downstream nodes. For example, the timing packet originator 240 may utilize the clock 215 to periodically transmit timing packets to one or more nodes to which the clock distributor 235 distributes the clock frequency. In some embodiments, the timing packet originator 240 may transmit this periodic timing packet stream continuously and indefinitely, within a recurrent verification window, on demand by the downstream node, or according to any schedule or other timing scheme that may be appropriate.

To enable verification of the local clock 215, the node 200 may be provided with a timing comparator 245. As will be described in greater detail below, the timing comparator 245 may include hardware or machine-executable instructions encoded on a machine-readable medium configured to receive a synchronous stream of timing packets from an upstream node and process the packets to verify the frequency of the clock 215. For example, the timing comparator may assume that, if the clock 215 frequency is in sync with the upstream clock, then the frequency of the timing packet stream will be in sync with the clock 215. If the two are out of sync, the timing comparator determines that the frequency recovered by the clock synchronization engine 230 is not valid. Various exemplary methods for comparing the frequency of the received timing packet stream to the clock 215 frequency will be described in greater detail below. After identifying an invalid sync, the node 200 may take steps to fix the sync or may notify a separate management system that the clocks are out of sync.

FIG. 3 illustrates an exemplary hardware diagram of a node 300 for distributing or receiving a clock frequency. The exemplary node 300 may correspond to node A 110, node B 120, or the exemplary node 200. As shown, the hardware device 300 includes one or more system buses 310 that interconnect a processor 320, a memory 330, a user interface 340, a network interface 350, and a storage 360. It will be understood that FIG. 3 constitutes, in some respects, an abstraction and that the actual organization of the components of the node 300 may be more complex than illustrated. For example, the node 300 may be arranged in multiple planes such as a control plane and a data plane. Various other arrangements will be apparent.

The processor 320 may be any hardware device capable of executing instructions stored in memory 320 or storage 350. As such, the processor 320 may include one or more microprocessors, field programmable gate arrays (FPGAs), application-specific integrated circuits (ASICs), or other similar devices.

The memory 330 may include various memories such as, for example L1, L2, or L3 cache or system memory. As such, the memory 330 may include static random access memory (SRAM), dynamic RAM (DRAM), flash memory, read only memory (ROM), or other similar memory devices.

The user interface 340 may include one or more devices for enabling communication with a user such as an administrator. For example, the user interface 340 may include a display, a mouse, and a keyboard for receiving user commands.

The network interface 350 may include one or more devices for enabling communication with other hardware devices. For example, the network interface 350 may include a network interface card (NIC) configured to communicate according to the Ethernet protocol. Additionally, the network interface 350 may implement a TCP/IP stack for communication according to the TCP/IP protocols. Various alternative or additional hardware or configurations for the network interface 350 will be apparent.

The storage 360 may include one or more machine-readable storage media such as read-only memory (ROM), random-access memory (RAM), magnetic disk storage media, optical storage media, flash-memory devices, or similar storage media. In various embodiments, the storage 360 may store instructions for execution by the processor 320 or data upon with the processor 320 may operate. As shown, the storage 360 stores packet processing instructions 362, for enabling the forwarding or other processing of asynchronous or synchronous traffic, and clock synchronization instructions 364, for enabling the distribution or recovery of a clock frequency according to a frequency distribution technology. Additionally, the storage 360 may store timing packet origination instructions 366, for transmitting a stream of timing packets to enable a downstream node to verify a recovered frequency, or timing comparator instructions 368, for enabling the verification of a locally recovered frequency based on a received stream of timing packets.

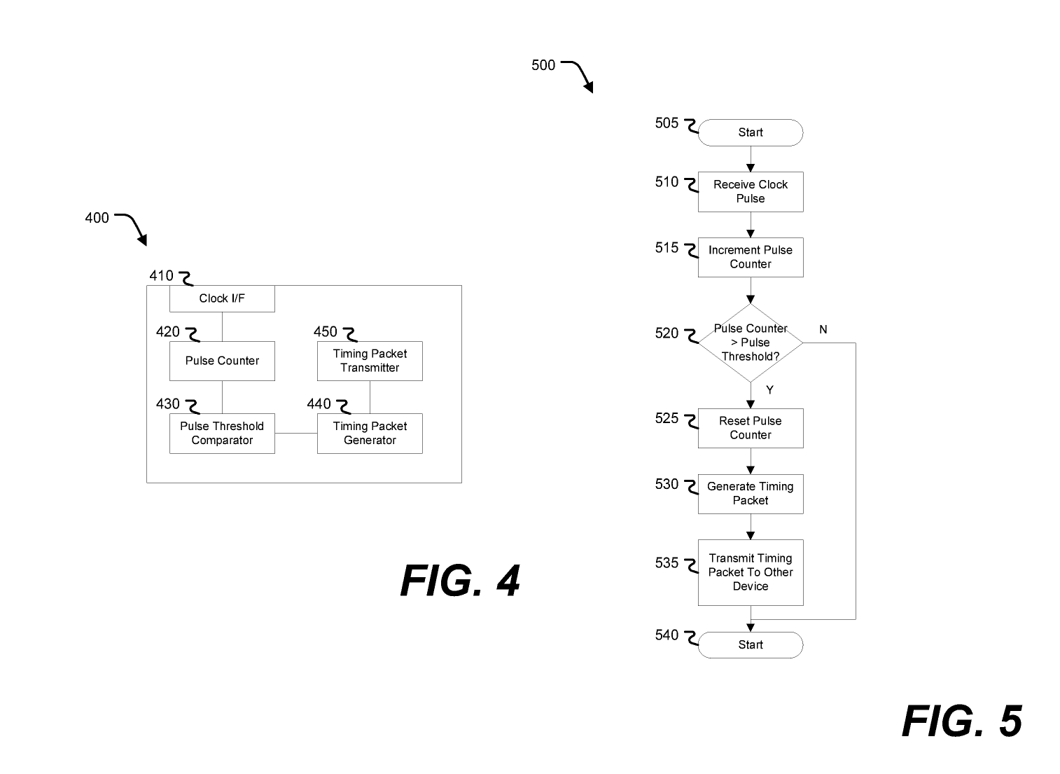

FIG. 4 illustrates an exemplary component diagram of an exemplary timing packet originator 400. The timing packet originator 400 may correspond to the timing packet originator 114 of the exemplary network 100 or the timing packet originator 240 of the exemplary node 200. Alternatively, the timing packet originator 400 may be deployed in a device other than the node that is also distributing the frequency to be verified. It will be understood that the various components included as a part of the timing packet originator 400 may be implemented in hardware or machine executable instructions encoded on a machine-readable medium for performing the functionality described herein.

As shown, the timing packet originator 400 includes a clock interface 410 that receives pulses from a system clock. The pulse counter 420, in turn, may count the number of pulses received via the clock interface 410. The pulse threshold comparator 430 may determine when the pulse counter exceeds some predetermined pulse threshold. For example, the pulse threshold comparator 430 may determine when the pulse counter exceeds 1000 (e.g., when configured to transmit a timing packet every 1000 clock pulses), 1 (e.g., when configured to transmit a timing packet every clock pulse), or a number that varies based on the local clock speed (e.g., when configured to transmit a packet every ten microseconds). Upon determining that the pulse counter has passed the pulse threshold, the pulse threshold comparator 430 may reset the pulse counter 420 to zero and informs the timing packet generator 440 that a timing packet should be transmitted. In some embodiments, such as embodiments wherein the timing packet originator 400 is configured to send a packet every clock pulse, the pulse threshold comparator 430 or pulse counter 420 may not be present, and the clock pulse may be directly received by the timing packet generator 440.

Upon receiving a signal, the timing packet generator 440 may generate a new timing packet to be transmitted to at least one device for verifying a recovered frequency. In embodiments wherein the timing packet originator 400 is deployed within the same node that distributes the frequency, the timing packet generator 440 may generate a packet for each device to which the frequency is distributed. Alternatively, the timing packet generator 440 may generate a packet for each device that has requested, or has been otherwise registered with the local device, to receive a stream of timing packets. As explained above, the timing packet may carry an empty payload or a predetermined amount of dummy data. After generation of a timing packet, the timing packet transmitter 450 may transmit, via a network interface, the packet toward the appropriate node.

FIG. 5 illustrates an exemplary method 500 for originating timing packets. The method 500 may be performed by a timing packet originator 114, 240, 400. It will be understood that various other methods may be used to generate a synchronous stream of timing packets and that the method 500 is but one example.

The method 505 may begin in step 505 and proceed to step 510 where the timing packet originator receives a clock pulse. In various embodiments, the method 500 may be implemented to execute as a result of the clock pulse received in step 510 such as, for example, as part of a processor interrupt that is raised on each clock pulse. In such embodiments, steps 505 and 510 may be viewed as one in the same. The timing packet originator may then, in step 515, increment a pulse counter and, in step 520, determine whether a predetermined pulse threshold has been exceeded by the pulse counter. If the pulse counter has not yet exceeded the pulse threshold, the method 500 may proceed to end in step 540.

Otherwise, the method 500 proceeds to step 525 where the timing packet originator resets the pulse counter in anticipation of the next timing packet transmission. Then, in step 530, the timing packet originator generates the timing packet and, in step 535, transmits it to one or more other devices for use in verifying a recovered clock. The method may then proceed to end in step 540.

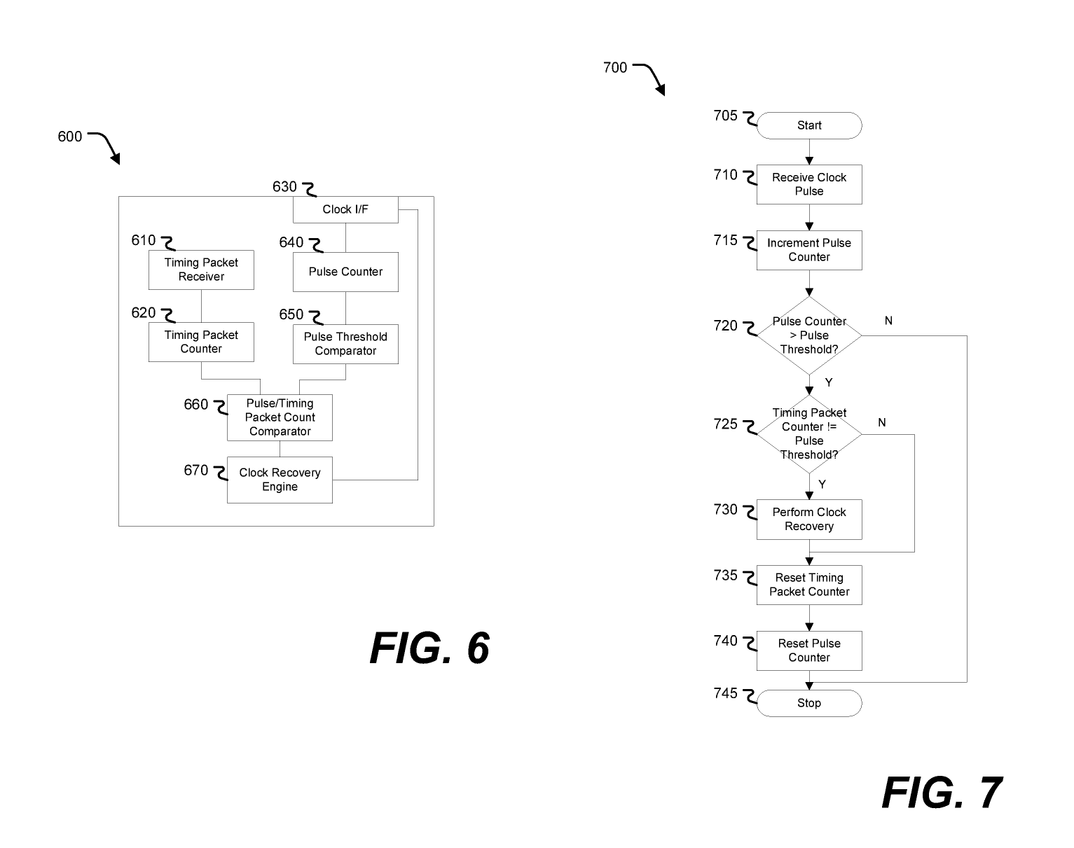

FIG. 6 illustrates an exemplary component diagram of an exemplary timing comparator 600 according to a first embodiment. The timing comparator 600 may correspond to the timing comparator 124 of the exemplary network 100 or the timing comparator 245 of the exemplary node 200. It will be understood that the various components included as a part of the timing comparator 600 may be implemented in hardware or machine executable instructions encoded on a machine-readable medium for performing the functionality described herein.

As shown, the timing comparator 600 includes a timing packet receiver 610 configured to receive a stream of timing packets via a network interface. The timing packet counter 620 may increment a counter value as each timing packet is received at the timing packet receiver, thereby keeping track of the number of timing packets received during a time window. After counting the packet, the timing comparator 600 may discard the timing packet.

The timing comparator 600 also includes a clock interface that receives pulses from a system clock. The pulse counter 640, in turn, may count the number of pulses received via the clock interface 630. The pulse threshold comparator 650 may determine when the pulse counter exceeds some predetermined pulse threshold. For example, the pulse threshold comparator 650 may determine when the pulse counter exceeds 1000 (e.g., when configured to expect a timing packet every 1000 clock pulses), 1 (e.g., when configured to expect a timing packet every clock pulse), or a number that varies based on the local clock speed (e.g., when configured to expect a packet every ten microseconds). Upon determining that the pulse counter has passed the pulse threshold, the pulse threshold comparator 650 informs the pulse/timing packet count comparator 660 that the counts should be compared for verifying the recovered frequency.

Upon receiving a signal, the pulse/timing packet count comparator 660 may compare the value of the timing packet counter 620 to the value of the pulse counter 640 or the predetermined threshold. If the compared values are equal, the pulse/timing packet count comparator 660 may determine that the recovered frequency is valid and perform no further actions or indicate to some other component or device the validity of the recovered frequency. Otherwise, the pulse/timing packet count comparator 660 indicates to the clock recovery engine 670 that the recovered frequency is out of sync with the source frequency or an intended frequency.

The clock recovery engine 670 communicates with the clock via the clock interface 630 to at least indicate that the recovered frequency is incorrect. For example, the clock recovery engine 670 may send a simple indication that the frequency is out of sync or an indication of the magnitude of the frequency difference such as the difference between the timing packet counter and the pulse counter or pulse threshold. The clock (not shown) may then take measures to reestablish synchronization. Alternatively, the clock recovery engine 670 may reform such remedial function itself by determining more correct frequency based on the difference in counts and instructing the clock to operate according to the more correct frequency. As yet another alternative, the clock recovery engine 670 may not communicate with the clock at all and, instead, may communicate with an internal or external management system to indicate that the recovered signal is out of sync. The management system may then perform such remedial measures.

It will be apparent that various components described with respect to the timing comparator 600 are similar to components described with respect to the timing packet originator 400. In some embodiments wherein a device implements both a timing comparator and a timing packet originator, such similar components may be shared. For example, the device may include a single clock interface 410, 630; pulse counter 420,640; and pulse threshold comparator 430,650. In some such embodiments, the pulse threshold comparator 430,650 may be configured to signal both the timing packet generator 440 and pulse/timing packet count comparator 660 upon the pulse count exceeding the threshold. In other such embodiments, the pulse counter 420, 640 may maintain two separate counts and the pulse threshold comparator 430,650 may maintain two separate pulse thresholds for the purposes of timing comparison and timing packet origination, respectively.

In various embodiments, the local clock may be synchronized with the frequency of the source clock but not the phase. In such embodiments, it may be possible for a properly synchronized clock to produce a different count from the number of received packets due to the shift in phase or network delay. For example, the timing comparator 600 may receive one more or one fewer timing packet than expected based on the pulse threshold. Such a possibility may be accounted for by implementing an acceptable margin of differentiation in the pulse/timing packet count comparator 660, wherein if the counts are only off by a small value within the margin, the pulse/timing packet count comparator 660 will not signal the clock recovery engine 670. As other alternatives, the pulse counter 640 may be configured to begin counting when the timing packet receiver 610 receives the first timing packet or that pulse/timing packet count comparator 660 may average multiple windows of counter differences prior to signaling the clock recovery engine 670. Alternatively, rather than accounting for phase shift, the node may ensure that the local clock is synchronized on both frequency and phase, according to any method. For example, the transmission of timing packets may be aligned with one or more specific points in the phase, such that the phase may be recovered at the receiver.

FIG. 7 illustrates an exemplary method 700 for analyzing timing packets according to the first embodiment. The method 700 may be performed by a timing comparator 124, 245, 600. It will be understood that various other methods may be used to analyze a synchronous stream of timing packets and that the method 700 is but one example. The method 700 may be implemented to operate in conjunction with another method (not shown) that increments a timing message counter upon receipt of a timing message. Such other method may be implemented as a processor interrupt that is raised on receipt of a timing packet. Possibilities for implementation of such a method will be apparent.

The method 700 may begin in step 705 and proceed to step 710 where the timing comparator receives a clock pulse. In various embodiments, the method 700 may be implemented to execute as a result of the clock pulse received in step 710 such as, for example, as part of a processor interrupt that is raised on each clock pulse. In such embodiments, steps 705 and 710 may be viewed as one in the same. The timing comparator may then, in step 715, increment a pulse counter and, in step 720, determine whether a predetermined pulse threshold has been exceeded by the pulse counter. If the pulse counter has not yet exceeded the pulse threshold, the method 700 may proceed to end in step 745.

Otherwise, the method 700 proceeds to step 725 where the timing comparator determines whether the timing packet counter indicates that the local clock frequency is not properly synchronized. For example, the timing comparator may determine whether the timing packet counter is equal to the pulse threshold (which may also indicate the expected number of received timing packets). As noted above, the timing comparator may alternatively determine whether the timing packet counter falls within a predetermined margin of the threshold.

If the timing comparator determines, in step 725, that the recovered frequency is in sync with the source frequency, the method 700 proceeds to step 735. Otherwise, the method 700 proceeds to step 730 where the timing comparator may perform clock recovery. As noted above, clock recovery may include sending an indication that the frequency is out of sync to the clock or to another management component or device, or may include setting the frequency of the clock to a more correct frequency as determined by the difference between the timing packet counter and the pulse threshold. The method 700 then proceeds to step 735. The timing comparator then resets the timing packet counter in step 735 and resets the pulse counter in step 740 to prepare for the next window of timing packets. The method then ends in step 745.

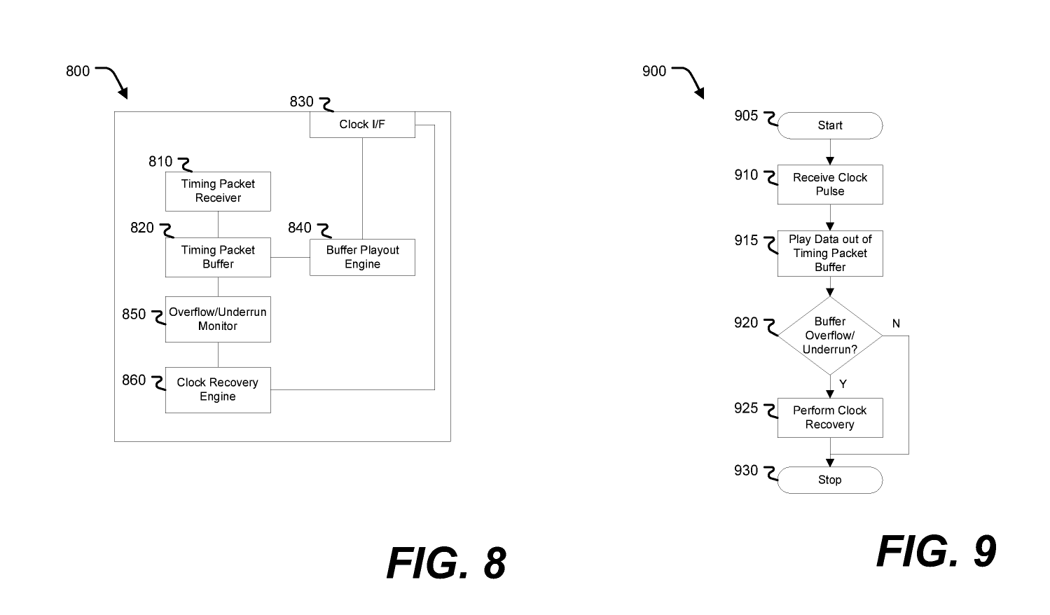

FIG. 8 illustrates an exemplary component diagram of an exemplary timing comparator 800 according to a second embodiment. The timing comparator 800 may correspond to the timing comparator 124 of the exemplary network 100 or the timing comparator 245 of the exemplary node 200. It will be understood that the various components included as a part of the timing comparator 800 may be implemented in hardware or machine executable instructions encoded on a machine-readable medium for performing the functionality described herein.

As shown, the timing comparator 600 includes a timing packet receiver 610 configured to receive a stream of timing packets via a network interface. The timing packet receiver 610 may insert each packet, an indication of each packet, a predetermined value, payload data from each packet, or locally-generated dummy data for each packet into the timing packet buffer 820. The timing packet buffer 820 may be a counter, a FIFO queue, or other data structure that stores data to be “played out” by the buffer playout engine 840.

The timing comparator 600 also includes a clock interface that receives pulses from a system clock. The buffer playout engine 840 may remove data from the timing packet buffer 820 periodically based on pulses received via the clock interface. “Playing out” of data may include, for example, decrementing a value (e.g., when the timing packet buffer 820 is a counter) or removing and discarding a packet or a predetermined amount of data from the timing packet buffer (e.g., when the timing packet buffer is a queue. In some embodiments, the buffer playout engine 840 is configured to play out data from the timing packet buffer 820 on each pulse while, in other embodiments, the buffer playout engine 840 is configured to play out data after a predetermined number of pulses. In some embodiments wherein the buffer playout engine 840 is configured to play out data after a predetermined number of pulses, the timing comparator 800 may include a pulse counter and pulse threshold comparator (not shown), similar to those previously described, disposed between the clock interface 830 and buffer playout engine 840. In some embodiments, at the beginning of the timing packet stream, the buffer playout engine 840 waits until the timing packet buffer 820 reaches a predetermined fill level (e.g., half full) before beginning playout of data.

As one example of the operation of the timing packet buffer 820, the timing packet buffer 820 is implemented a simple counter. Upon receiving a timing packet, the timing packet receiver 810 adds a value of 10 to the current counter value. The value 10 may be determined based on an expectation that one packet is to be received every 10 clock cycles. Then, on each clock pulse, the buffer playout engine 840 decrements the counter value by one. In this manner, the buffer playout engine 840 may be configured to operate on each clock pulse and thereby not use a separate pulse counter.

As another example of the operation of the timing packet buffer 820, the timing packet buffer 820 is implemented as a data queue. Upon receiving a timing packet, the timing packet receiver 810 enqueues the packet into the timing packet buffer 820. Then, on every 20 clock pulses, the buffer playout engine 840 dequeues and discards the packet from the timing packet buffer 820. It will be apparent that, in implementations where the packets are empty or only provided with dummy data, the ordering of the packet dequeue may not be important and, as such, the timing packet buffer 820 may be implemented as other another data structure in this and other embodiments, such as a stack or an unordered collection.

As yet another example of the operation of the timing packet buffer 820, the timing packet buffer 820 is implemented as a data queue. Upon receiving a timing packet, the timing packet receiver 810 generates and enqueues five bytes of dummy data into the timing packet buffer 820. Then, on each clock pulse, the buffer playout engine 840 dequeues and discards one byte of data from the timing packet buffer.

As data enters and leaves the timing packet buffer, the overflow/underrun monitor 850 continually or periodically monitors the fill level of the buffer to determine whether the fill level has deviated from a target fill level by some predetermined amount. If so, the overflow/underrun monitor 850 indicates to the clock recovery engine 860 that the recovered frequency is out of sync with the source frequency or an intended frequency.

The clock recovery engine 860 communicates with the clock via the clock interface 83 to at least indicate that the recovered frequency is incorrect. For example, the clock recovery engine 860 may send a simple indication that the frequency is out of sync or an indication of the magnitude of the frequency difference such as the difference between the timing packet counter and the pulse counter or pulse threshold. The clock (not shown) may then take measures to reestablish synchronization. Alternatively, the clock recovery engine 860 may reform such remedial function itself by determining more correct frequency based on the difference in counts and instructing the clock to operate according to the more correct frequency. As yet another alternative, the clock recovery engine 860 may not communicate with the clock at all and, instead, may communicate with an internal or external management system to indicate that the recovered signal is out of sync. The management system may then perform such remedial measures.

It will be apparent that various components described with respect to the timing comparator 800 may already be implemented in a device that supports forwarding or other processing of synchronous messages. For example, if node 200 includes the synchronous packet processor 225, the synchronous packet processor may include a timing packet buffer, buffer playout engine, and overflow/underrun monitor (not shown). In such embodiments, the timing comparator 800 may utilize such existing functionality by directing received timing packets to a buffer of the synchronous packet processor 225 and configuring the synchronous packet processor 225 to report any overflow or underrun to the clock recovery engine 860. In such embodiments, the coopted components from the synchronous packet processor 225 may also be viewed as components of the timing comparator 800. Various other modifications will be apparent.

FIG. 9 illustrates an exemplary method 900 for analyzing timing packets according to the second embodiment. The method 900 may be performed by a timing comparator 124, 245, 800. It will be understood that various other methods may be used to analyze a synchronous stream of timing packets and that the method 900 is but one example. The method 900 may be implemented to operate in conjunction with another method (not shown) that enqueues timing packets, data, indications, etc into a buffer. Such other method may be implemented as a processor interrupt that is raised on receipt of a timing packet. Possibilities for implementation of such a method will be apparent.

The method 900 begins in step 905 and proceeds to step 910 where the timing comparator receives a clock pulse. In various embodiments, the method 900 may be implemented to execute as a result of the clock pulse received in step 910 such as, for example, as part of a processor interrupt that is raised on each clock pulse. In such embodiments, steps 905 and 910 may be viewed as one in the same. In step 915, the timing comparator plays an amount of data out of the timing packet buffer. As detailed above and depending on the implementation, step 915 may entail decrementing a counter by a predefined amount, dequeuing and discarding one or more timing packets, or dequeuing and discarding a predetermined amount of data. As also noted above, some embodiments may wait for the buffer to reach a predetermined target fill level (e.g., halfway or a predetermined counter value) prior to playing out data from the buffer. In such embodiments, the method 900 may only reach step 915 if the buffer has previously reached the target fill level as indicated by, for example, a flag that is set once the target fill level is attained/

In step 920, the timing may determine whether the timing packet buffer is experiencing buffer overflow or underrun. For example, the timing comparator may determine whether the fill level or value of the buffer deviates from a target fill level or value by more than some predetermined acceptable margin. In some embodiments, the timing comparator may account for discrepencies between the rates at which data is enqueued and dequeued from the timing packet buffer (e.g., in embodiments where receipt of a timing packet causes a counter to be incremented by ten but the counter is decremented by one on each clock pulse) by averaging multiple samples over time before declaring an overflow or underrun.

If no buffer overflow or underrun is declared, the method 900 proceeds directly to end in step 930. Otherwise, the method 900 proceeds to step 925 where the timing comparator may perform clock recovery. As noted above, clock recovery may include sending an indication that the frequency is out of sync to the clock or to another management component or device, or may include setting the frequency of the clock to a more correct frequency as determined by the difference between the timing packet counter and the pulse threshold. The method 900 then proceeds to step 930.

According to the foregoing, various embodiments enable verification of a recovered clock frequency in the absence of synchronous traffic. For example, by establishing a synchronous timing packet stream, the downstream device may employ various methods to verify the recovered clock frequency against the rate at which packets are received on the synchronous timing packet stream. Various additional benefits will be apparent in view of the above description.

It should be apparent from the foregoing description that various exemplary embodiments of the invention may be implemented in hardware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media. Further, as used herein, the term “processor” will be understood to encompass a microprocessor, field programmable gate array (FPGA), application-specific integrated circuit (ASIC), or any other device capable of performing the functions described herein.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A network device for enabling downstream monitoring clock accuracy comprising:
a network interface configured to communicate with a downstream device; and
a processor configured to:
communicate with the downstream device via the network interface according to a frequency distribution scheme to distribute a local clock frequency to the downstream device,
periodically generate timing packets based on the local clock frequency, and
transmit the generated timing packets to the downstream device via the network interface as a first synchronous stream.

2. The network device of claim 1, wherein, in periodically generating the timing packets based on the local clock frequency, the processor is configured to:
count clock pulses generated according to the local clock frequency; and
generate a timing packet when a number of counted clock pulses exceeds a predetermined threshold.

3. The network device of claim 1, wherein the processor is further configured to:
receive an asynchronous stream of data packets; and
forward the asynchronous stream of data packets to the downstream node via the network interface.

4. The network device of claim 1, wherein the processor is further configured to:
communicate with an upstream device according to the frequency distribution scheme to establish the local clock frequency;
receive timing packets as part of a second synchronous stream;
verify the accuracy of the local clock frequency based on comparing the second synchronous stream to the local clock frequency.

5. The network device of claim 4, wherein the processor is further configured to:
initiate recovery for the local clock frequency when the processor determines, as a result of verifying the accuracy of the local clock frequency based on comparing the second synchronous stream to the local clock frequency, that the local clock frequency is not sufficiently accurate.

6. The network device of claim 4, wherein, in verifying the accuracy of the local clock frequency based on comparing the second synchronous stream to the local clock frequency, the processor is configured to:
count a number of timing packets received via the second synchronous stream within a window;
estimate a number of timing packets expected to be received via the second synchronous stream within the window based on the local clock frequency; and
compare the counted number to the estimated number.

7. The network device of claim 4, wherein, in verifying the accuracy of the local clock frequency based on comparing the second synchronous stream to the local clock frequency, the processor is configured to:
add data into a buffer based on the second synchronous stream,
remove data from the buffer based on the local clock frequency, and
monitor the buffer for at least one of overrun and underrun.

8. A method performed by a network device for enabling downstream monitoring clock accuracy comprising:
communicating, by the network device, with the downstream device according to a frequency distribution scheme to distribute a local clock frequency to the downstream device;
periodically generating timing packets based on the local clock frequency; and
transmitting the generated timing packets to the downstream device as a first synchronous stream.

9. The method of claim 8, wherein periodically generating the timing packets based on the local clock frequency comprises:
counting clock pulses generated according to the local clock frequency; and
generating a timing packet when a number of counted clock pulses exceeds a predetermined threshold.

10. The method of claim 8, further comprising:
receiving an asynchronous stream of data packets; and
forwarding the asynchronous stream of data packets to the downstream node via the network interface.

11. The method of claim 8, further comprising:
communicating with an upstream device according to the frequency distribution scheme to establish the local clock frequency;
receiving timing packets as part of a second synchronous stream;
verifying the accuracy of the local clock frequency based on comparing the second synchronous stream to the local clock frequency.

12. The method of claim 11, further comprising:
initiating recovery for the local clock frequency when the result of verifying the accuracy of the local clock frequency based on comparing the second synchronous stream to the local clock frequency indicates that the local clock frequency is not sufficiently accurate.

13. The method of claim 11, wherein verifying the accuracy of the local clock frequency based on comparing the second synchronous stream to the local clock frequency comprises:
counting a number of timing packets received via the second synchronous stream within a window;
estimating a number of timing packets expected to be received via the second synchronous stream within the window based on the local clock frequency; and
comparing the counted number to the estimated number.

14. The method of claim 11, wherein verifying the accuracy of the local clock frequency based on comparing the second synchronous stream to the local clock frequency comprises:
adding data into a buffer based on the second synchronous stream,
removing data from the buffer based on the local clock frequency, and
monitoring the buffer for at least one of overrun and underrun.

15. A non-transitory machine-readable storage medium encoded with instructions for execution by a network device for enabling downstream monitoring clock accuracy comprising:
instructions for communicating, by the network device, with the downstream device according to a frequency distribution scheme to distribute a local clock frequency to the downstream device;
instructions for periodically generating timing packets based on the local clock frequency; and
instructions for transmitting the generated timing packets to the downstream device as a first synchronous stream.

16. The non-transitory machine-readable storage medium of claim 15, wherein the instructions for periodically generating the timing packets based on the local clock frequency comprise:
instructions for counting clock pulses generated according to the local clock frequency; and
instructions for generating a timing packet when a number of counted clock pulses exceeds a predetermined threshold.

17. The non-transitory machine-readable storage medium of claim 15, further comprising:
instructions for communicating with an upstream device according to the frequency distribution scheme to establish the local clock frequency;
instructions for receiving timing packets as part of a second synchronous stream;
instructions for verifying the accuracy of the local clock frequency based on comparing the second synchronous stream to the local clock frequency.

18. The non-transitory machine-readable storage medium of claim 17, further comprising:
instructions for initiating recovery for the local clock frequency when the result of executing the instructions for verifying the accuracy of the local clock frequency based on comparing the second synchronous stream to the local clock frequency indicates that the local clock frequency is not sufficiently accurate.

19. The non-transitory machine-readable storage medium of claim 17, wherein the instructions for verifying the accuracy of the local clock frequency based on comparing the second synchronous stream to the local clock frequency comprise:
instructions for counting a number of timing packets received via the second synchronous stream within a window;
instructions for estimating a number of timing packets expected to be received via the second synchronous stream within the window based on the local clock frequency; and
instructions for comparing the counted number to the estimated number.

20. The non-transitory machine-readable storage medium of claim 17, wherein the instructions for verifying the accuracy of the local clock frequency based on comparing the second synchronous stream to the local clock frequency comprises:
instructions for adding data into a buffer based on the second synchronous stream,
instructions for removing data from the buffer based on the local clock frequency, and
instructions for monitoring the buffer for at least one of overrun and underrun.
